(19) United States
(12) Patent Application Publication
(10) Pub. No.: US 2017/0122506 A1
(43) Pub. Date: May 4, 2017

(54) Personal Safety Light

(71) Applicant: Dale Collins, Ypsilanti, MI (US)

(72) Inventor: Dale Collins, Ypsilanti, MI (US)

(21) Appl. No.: 14/929,088

(22) Filed: Oct. 30, 2015

(51) Int. Cl. F21L 4/02; F21V 7/22; F21V 23/04

(52) U.S. Cl. CPC F21L 4/027; F21V 23/0414; F21V 23/0492; F21V 7/22; F21Y 2101/02; F21Y 2113/005

(57) ABSTRACT

The present invention is a high-intensity personal safety light. The personal safety light has a plurality of LEDs in a housing with a reflector. The personal safety light has an optional rechargeable battery. The personal safety light can either flash or be continuously on. The personal safety light has a motion sensor, so that, when worn, it turns on.

### FIELD OF INVENTION

This invention relates to illumination, specifically to wearable personal safety lights.

### BACKGROUND OF INVENTION

From 1969 to 2009, the percentage of U.S. children who walked to school declined from 48% to 13%, nationwide. Over the last few years, however, the number of children walking to school is climbing. There are several drivers for this. A number of school districts have reduced bus transportation because of budget issues, meaning that more children have to walk to school. There has been a drive to reform education in the U.S., leading to more charter schools. More children are attending neighborhood-based charter schools, rather than their local public schools. Charter schools rarely provide transportation. Additionally, more focus is being placed on the physical fitness of children, because there is an epidemic of childhood obesity in the U.S. As part of a coordinated effort to get children more physical activity, children are being encouraged to walk or bike to school by their school district. Lastly, many parents have decided that their children need to be “free range”, meaning that the children need to walk, bike, and play without parental supervision.

The changes in walking patterns is especially pronounced in urban areas. Urban school are disproportionately experiencing budget problems, resulting in many urban and older suburban districts restricting bussing of children.

At the same time that more children are, once again, walking to school, the U.S. has lengthened the daylight saving season. In 1966, the Uniform Time Act set Daylight Savings as extending from the last Sunday in April through the last Sunday in October. In 2005, the Energy Policy Act set Daylight savings time in the U.S. as lasting from the second Sunday in March through the first Sunday in November. As a result, children are increasingly walking to school in the dark.

The National Safe Routes Partnership states that 23,000 children, aged 5-15, were injured going to or from school in 2009. Additionally, 250 children were killed walking or biking to school in 2009. The cost for the fatalities, alone was in excess of $800 million. The National Safe Routes Partnership states that the risk of injury is 6 times greater when the child has to commute near or across a high traffic volume road. Urban areas, and suburban areas close to the city center, tend to have a higher proportion of high traffic volume roads.

There is little new safety equipment or systems for children walking or biking to school. One simple solution would be to illuminate the children. In the 1970s, there were many studies that showed that daytime running lamps for vehicles reduced collisions, both between vehicles and between vehicles and pedestrians. Daytime running lamps were originally produced by automakers in Scandinavian countries, because of the long hours of darkness and twilight throughout the year. Starting in 1990, General Motors offered running lamps as standard equipment in the United States. The National Highway Transportation Safety Administration allows daytime running lamps, but does not require it.

The problem with most illumination devices for children is that they are relatively low power, limiting their effectiveness. Many of the flashlights, glowsticks, and other methods of illuminating a child generate less than 100 candelas. Many of them generate less than 20 candelas. This level of illumination is ineffective.

With the increase in children commuting via bike or walking, in the dark, in urban areas, there is a need for a wearable illumination device that is at least 250 candelas. The illumination device ought to be easily fastenable to a variety of clothing, and ought to be suitable for year-around use. Lastly, the illumination device ought to be inexpensive.

### PRIOR ART REVIEW

None of the current solutions in the prior art are ideal. Although some children use flashlights and glowsticks to make them conspicuous as they go to school, there is no widely market-accepted solution. The prior art, likewise, does not show an optimum solution.

There are solutions that can be used as personal safety lights, but none of them use high-intensity LEDs, allowing for more than 250 candelas of output. For example, U.S. Design Pat. No. D340,777, by named inventor Choi, is entitled, “Personal Safety Light” (“Choi '777”). Choi '777 teaches an LED personal safety light connected with a wrist-strap. The personal safety light has a largely rectangular cross-section with a peaked lid. As with all design patents, this is merely an ornamental design, and it has no functional claim. Choi '777 is essentially a low powered flashlight with a wrist-strap. U.S. Utility Pat. No. 7,312,773, by named inventors Herzen, et., al., is entitled, “Illuminated wearable ornament” (“Herzen '773”). Herzen '773 discloses an ornamental, wearable light that has scrolling or fixed message. The claimed invention can be attached or suspended from a person or building. Herzen '773 discloses an invention that is intended to convey a written message, which would be transmitted at a much lower intensity than that desired from an effective personal safety light. U.S. Utility Pat. No. 4,319,309, by named inventor Benoit, is entitled, “Safety light” (“Benoit '309”). Benoit '309 teaches a flashing safety light to be carried by the user. Benoit '309 does not use LEDs. Additionally, Benoit '309 has straps, like Choi '777. Benoit '309 does not disclose a high intensity safety light. U.S. Utility Pat. No. 8,840,263, by named inventor Jones, is entitled, “Safety light” (“Jones '263”). Jones '263 teaches an LED bandolero for use by motorcycle riders, in which the LEDs are enclosed in plastic tubes, like Christmas decorations or glowsticks. Jones '263 is not a particularly bright (intensity) invention, as it does not have any reflector, and it encapsulates the LEDs in a plastic tube. Jones '263 discloses a method by which the lighting pattern can be changed through the use of a mobile software application. The Jones '263 bandolero is not really suitable for a child due to brightness, cost and complexity issues. None of these examples disclosed a high intensity safety light.

A substantial amount of the personal safety light technology is focused on protecting people with disabled vehicles, or roadside rescue workers. For example, U.S. Utility Pat. No. 8,616,719, by named inventor Barze, is entitled, “Lighted safety vest device” (“Barze '719”). Barze '719 is a lighted vest intended to be worn by roadside workers. Barze '719 does not claim LEDs, although that aspect is disclosed by Barze '719 elsewhere in the specification. Barze '719 does not claim, and is not designed, to use high intensity LEDs. Barze '719 makes no specific claim as to light output. Barze '719 seems most intent on the spacing and arrangements of the lights on the face of the vest.

U.S. Utility Pat. Nos. 7,259,691 and 7,746,247, both by named inventor Kimbrough, are both entitled, “Wearable, attachable, or hand-held, super-bright, led based, textual, safety alert sign and portable emergency/work light” (“Kimbrough '691” and “Kimbrough '247”). Kimbrough '691 and Kimbrough '247 both teach a vest/bib that can be worn, and that would be capable of displaying a written message. Specifically, the message appears to be, “See Me.” Kimbrough '691 and Kimbrough '247 teach high intensity LEDs, arranged in two sets, so that they can write the specific message. However, the intensity of the LEDs is substantially compromised because they are placed on a vest or bib, without a reflector. Both Kimbrough patents would be expensive to implement. Additionally, the vest/bib, although adjustable, would limit the times of the year it could be worn. For example, a vest/bib that fits in the summer months would not necessarily fit over a winter coat.

The prior art fails to teach a safety light suitable for use by children going to and from school. Specifically, the prior art does not disclose a device that could be attached to outer clothing, or worn on the wrist, that is high intensity, and cheap. The present invention attempts to overcome this problem, by offering a device which should meet the markets unmet needs.

### SUMMARY OF THE INVENTION

The present invention is a personal safety light that can be worn on the wrist, or attached to the outer garment of a child. The personal safety light includes a plurality of high intensity LEDs, capable of achieving 250 lumens, or more. The LEDs are mounted on a printed circuit board (PCB). A reflector is interposed between the PCB and the LEDs. The reflector increases the brightness of the personal safety light. The reflector can be fabricated from polished aluminum, a mirror, or other suitable reflective materials. The LEDs, PCB, and reflector are enclosed in a durable housing. The housing is most economically made from plastic, such as ABS, LDPE, HDPE, polypropylene, or polycarbonate. A transparent plastic lens encloses the LEDs, PCB and reflector in the housing, allowing the light to be projected.

The personal safety light has an off/on switch. The off/on switch can be a simple push button. The off/on switch can also be incorporated into the personal safety light by either switching the device off and on based off of the radial relationship between the top and bottom portions of the personal safety light; or by pushing the top of the personal safety light into the bottom of the personal safety light. The radial and pushing controls can also be used to change the illumination mode, such as making the LEDs flash, or create a blinking pattern.

An alternative embodiment of the personal safety light would have a motion sensor, so that the light would turn off when not being worn by the user, thus preserving battery life. The motion sensor would also automatically turn the light back on when the user puts the personal safety light back on.

The personal safety light can come with a number of different attaching methods. In one embodiment, the personal safety light is attached with a wrist strap. In another embodiment, the personal safety light is attached with a two-part hook-and-loop fastener. One part of the hook and loop fastener is attached to the personal safety light. Another part of the hook and loop fastener is attached to the outer garment of the user, or something carried by the user, such as a backpack.

The personal safety light has a rechargeable battery, such as a lithium ion battery, as well as a replaceable battery option.

### BRIEF DESCRIPTION OF THE DRAWINGS

There are twelve relevant drawings. FIG. 1 is an isometric view of a personal safety light. FIG. 2 is side view of a personal safety light. FIG. 3 is a reverse isometric view of a personal safety light. FIG. 4 is reverse side view of a first embodiment of a personal safety light.

FIG. 5 is an isometric view of an alternative embodiment of the present invention. FIG. 6 is an elevated bottom view of the present invention.

FIG. 7 is an isometric view of the interior assembly of the present invention. FIG. 8 is an exploded view of the interior components of the present invention. FIG. 9 is an isometric view of the present invention with the lens removed.

FIG. 10 is an isometric view of the present invention with an alternative embodiment on/off switch. FIG. 11 is a side view of the present invention with an alternative embodiment on/off switch.

FIG. 12 is an inverted, bottom view of the present invention with a wrist strap.

### DETAILED DESCRIPTION OF THE PREFERRED EMBODIMENTS

The following description represents the inventors' current preferred embodiments. The description is not meant to limit the invention, but rather to illustrate its general principles of operation. Examples are illustrated with the accompanying drawings. A variety of drawings are offered, showing the present invention with optional configurations.

FIG. 1 and FIG. 2 show a representative, personal safety light 1. The personal safety light 1 has a housing defined by an upper portion 9 and a lower portion 4. The upper portion of the housing 9 has a rim 3 and a lateral surface 7. The rim 3 has an inner radius 6 and an outer radius 8. The lower portion of the housing 4 has a lateral surface 5. The personal safety light 1 has a lens 2. The lens 2 is made from a clear, hard material, such as glass or polycarbonate. The upper portion 9 and lower portion 4 of the housing are made from a strong durable plastic, such as polycarbonate, ABS, LDPE, HDPE, or polypropylene.

In FIG. 3 and FIG. 4, a reverse angle of the personal safety light 1 is shown. All the same elements are present: a lens 2, a rim 3 with an outer radius 8 and an inner radius 6, an upper portion of the housing 9 with a lateral surface 7, a lower portion of the housing 4 with a lateral 5 surface. The personal safety light 1 has a recharging outlet 10, to recharge a rechargeable battery (not shown). The recharging outlet has two recharging prongs 11. The prongs 11 are enclosed by a hard-shell connector housing 12, which can, itself, be made from ABS, LDPE, HDPE, or polypropylene. The hard-shell connector housing 12 can also be integrally molded with the rest of the upper portion of the housing 9.

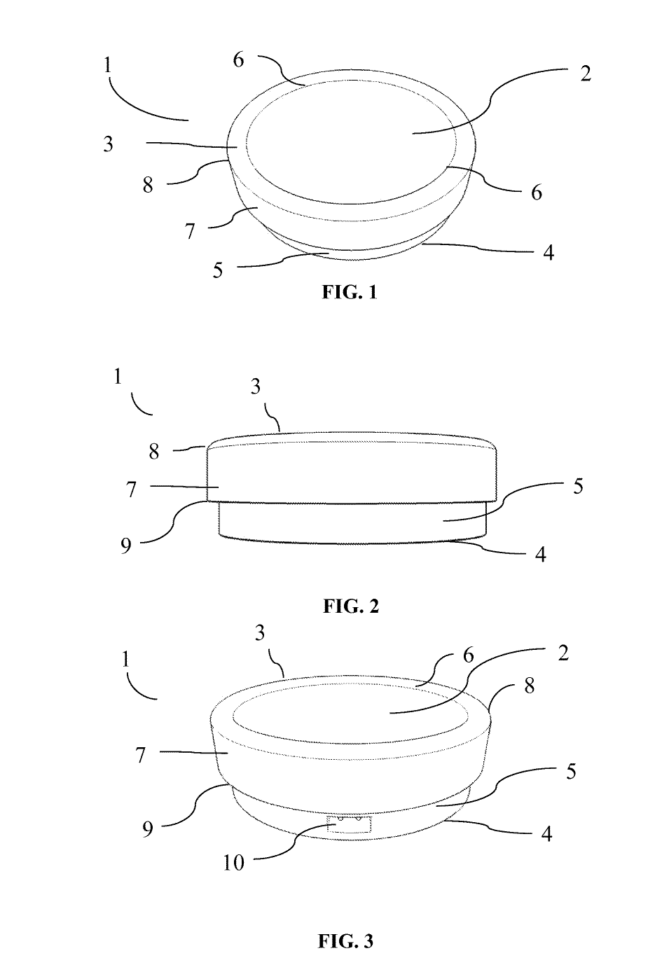

FIG. 5 shows the personal safety light 1 with an on/off button 13. All the same elements are present: a lens 2, a rim 3 with an outer radius 8, an upper portion of the housing 9 with a lateral surface 7, a lower portion of the housing 4 with a lateral 5 surface.

FIG. 6 shows a bottom view of the personal safety light 1. Many of the standard elements are visible: an upper portion of the housing 9 with a lateral surface 7, a lower portion of the housing 4 with a lateral 5 surface, and an on/off button 13. One-half of a hook-and-look connector 16 is visible, durably adhered to the bottom surface 15. A flanged lower surface 14 of the upper portion of the housing 9 is visible.

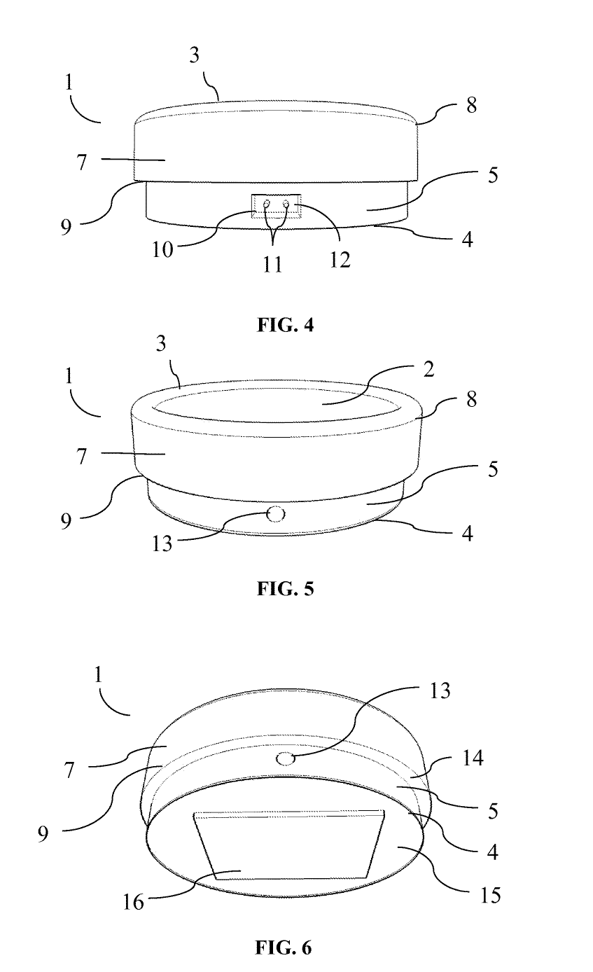

FIG. 7 shows the interior sub-assembly of the personal safety light 1. The major components of the interior sub-assembly 101 are a printed circuit board 120, a reflector 108, and a plurality of LEDs. No claim is made to the particular construction or configuration of the PCB 120, so the detailed surface of the PCB 120 is omitted. FIG. 8 shows an exploded view of the interior sub-assembly 101 in reference to the personal safety light 1. The relationship of the plurality of LEDs 111 to the reflector 108 and PCB 120 is shown. The interior sub-assembly 101 fits inside the personal safety light 1. FIG. 9 shows the interior sub-assembly 101 in situ in the personal safety light 1, with the lens 2 removed. The plurality of LEDs 111 sits on top of the reflector 108. The upper portion of the housing 9, with the exterior lateral surface 7 and interior lateral surface 27 encloses the LEDs 111 and reflector 108. The reflector 108 can be optionally notched, or have an extension 118, in order to concentrate or direct the LED 111 light beam.

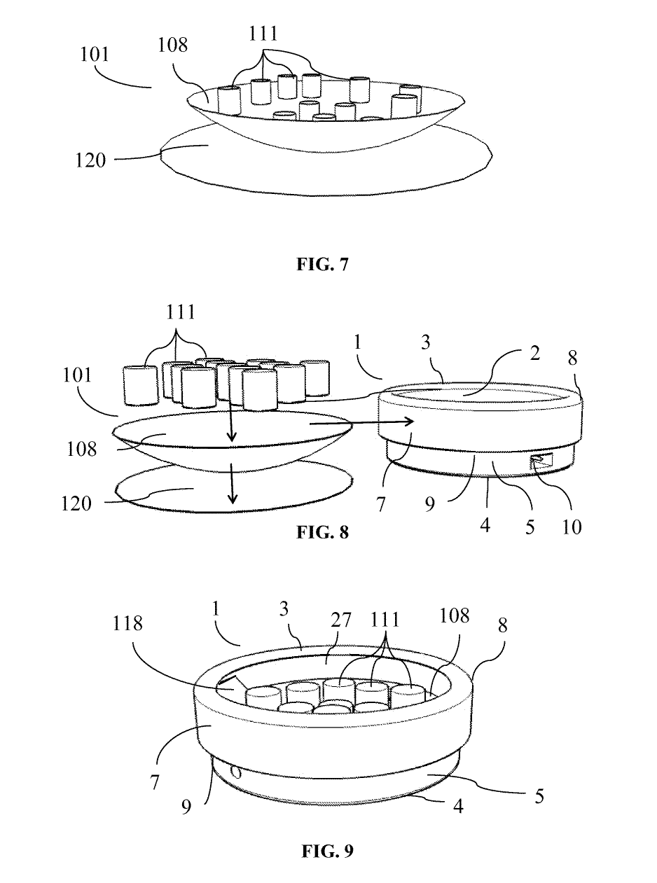

The personal safety light 1 may have an on/off button 13. As shown in FIG. 10 and FIG. 11, the on/off function can also be handled with an embedded switch. In FIG. 10, the upper portion of the housing 9 is twisted 25, in order to effect the on/off operation. In FIG. 11, the personal safety light 1 is pushed 26 in order to effect the on/off operation. The twisting motion 25 or the pushing motion 26 can also be used to change flashing modes on the personal safety light 1.

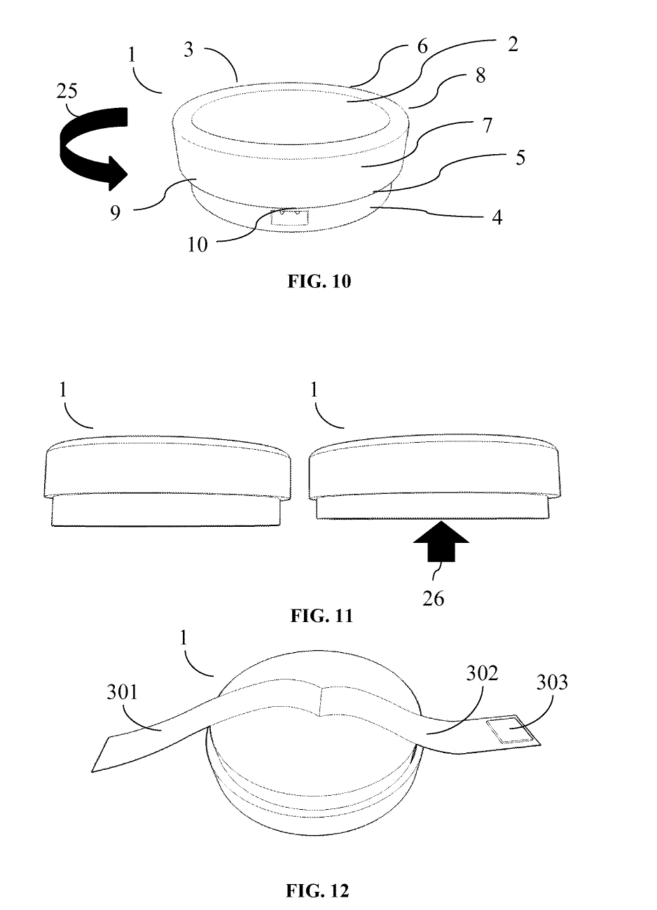

FIG. 12 shows the personal safety light 1 with an optional wrist strap, comprised of two portions 301, 302. The strap is secured with two pieces of hook-and-loop fastener 303, only one of which is visible. The strap may, alternatively, be designed like a watch band, with a plurality of linear holes on one strap, opposed to a buckle, on the other strap.

I claim:

1. A personal safety light comprised of an upper housing portion; a lower housing portion; a lens; two controls; and an interior assembly; wherein the upper housing portion has an exterior lateral surface, an interior lateral surface, a lower flange, and a rim; wherein the lower housing portion has a lateral surface and a round bottom surface; and wherein the interior assembly is comprised of a printed circuit board (“PCB”), a reflector, and a plurality of high intensity LEDs.

2. The personal safety light in claim 1, wherein the plurality of high intensity LEDs output at least 250 candelas of luminous intensity, in aggregate.

3. The personal safety light in claim 1, wherein the plurality of high intensity LEDs output at least 500 candelas of luminous intensity, in aggregate.

4. The personal safety light in claim 1, wherein the personal safety light, the upper housing portion lateral surface, and the lower housing portion lateral surface are all cylindrical.

5. The personal safety light in claim 1, further comprising a rechargeable battery, a rechargeable battery outlet, and a cord and plug assembly that attaches the rechargeable battery outlet to a standard electrical outlet.

6. The personal safety light in claim 1, wherein one control turns the personal safety light on and off; and the other control changes the LED output from continuous to flashing.

7. The personal safety light in claim 5, wherein at least one control is a push button.

8. The personal safety light in claim 5, wherein at least one control is effected by twisting the upper portion of the housing with respect to the lower portion of the housing.

9. The personal safety light in claim 5, wherein at least one control is effected by pushing the upper portion of the housing into the lower portion of the housing.

10. The personal safety light in claim 1, wherein the lens is made from polycarbonate.

11. The personal safety light in claim 1, wherein the lens is made from glass.

12. The personal safety light in claim 1, wherein the upper and lower portion of the housing are fabricated from at least one of ABS, LDPE, HDPE, and polypropylene.

13. The personal safety light in claim 1, wherein one half of a hook-and-loop fastener is attached to the round bottom surface of the personal safety light's lower housing portion.

14. The personal safety light in claim 1, wherein a strap is connected to the round bottom surface of the personal safety light's lower housing portion, in order that the personal safety light may be worn.

15. The personal safety light in claim 1, further comprising a motion sensor that turns the personal safety light off when no motion is sensed and turns the personal safety light on when motion is sensed.

16. The personal safety light in claim 1, wherein at least some of the plurality of LEDs are red.

17. The personal safety light in claim 1, wherein at least some of the plurality of LEDs are blue.

18. The personal safety light in claim 1, wherein at least some of the plurality of LEDs are green.

19. The personal safety light in claim 1, wherein the reflector is fabricated from polished aluminum.

20. The personal safety light in claim 1, wherein the reflector has extension areas and cut-out areas, intended to help direct the light output.
